(19) United States
(12) Patent Application Publication
(10) Pub. No.: US 2006/0032110 A1
(43) Pub. Date: Feb. 16, 2006

(54) Trapping device

(76) Inventor: Keng-Ming Yang, Taipei City (TW)

Correspondence Address: Keng-Ming Yang, 7F., No. 213, Civic Boulevard, Sec. 4, Taipei, 105, TW

(21) Appl. No.: 10/918,724

(22) Filed: Aug. 16, 2004

(51) Int. Cl. A01M 23/04

(52) U.S. Cl. 43/60

(57) ABSTRACT

A trapping device includes upper lure and lower detention compartments, and a trapping mechanism. The trapping mechanism includes infrared sensors provided in the lure compartment, first and second trapdoors, and a control circuit board for receiving signals from the infrared sensors to pivotally turn the first and the second trapdoor. When an animal/insect enters the lure compartment and passes through the infrared sensors, the first trapdoor is pivotally turned from a horizontal to a vertical position to confine the animal/insect in a rear room of the lure compartment, and the second trapdoor from a horizontal to a vertical position to open a floor opening communicating the lure and the detention compartment to trap the animal/insect in the detention compartment. The second trapdoor restores to the horizontal position to close the floor opening when a preset time passed, and the first trapdoor is returned to the horizontal position 20 seconds later.

### FIELD OF THE INVENTION

The present invention relates to a trapping device, and more particularly to a trapping device having a first trapdoor that is pivotally turned from a horizontal to a vertical position to confine an animal/insect entered an upper space of the trapping device and passed infrared sensors provided in the upper space, and a second trapdoor that is correspondingly turned from a horizontal to a vertical position to open a lower space of the trapping device to trap the animal/insect in the lower space. The first trapdoor returns to the horizontal position 20 seconds later after the second trapdoor is returned to the horizontal position when a preset time passed.

### BACKGROUND OF THE INVENTION

Mice and cockroaches are ugly and bite articles to contaminate human's food and carry bacteria and viruses to different places. To trap and kill mice and cockroaches, people have designed various ways, including poison baits. Improperly positioned poison baits would also endanger human beings, and poisoned mice and cockroaches tend to hide and die at dark and invisible places to produce very bad odor. The use of trapping devices with baits, including mouse cages, cockroach boxes, etc., is another common way to catch mice and cockroaches. Conventional mouse cages and cockroach boxes are designed for catching mice and cockroaches, respectively, and usually have a limited catching capacity, such as, for example, one mouse cage for one mouse. It is clearly the conventional mouse cages and cockroach boxes are ineffective for mice and cockroaches that multiply rapidly. Moreover, it is inconvenient and uneconomical to prepare two different types of capacity-limited trapping devices at places with mice and cockroaches.

It is therefore desirable to develop a trapping device that catches a large amount of mice and cockroaches at the same time to improve people's living quality.

### SUMMARY OF THE INVENTION

A primary object of the present invention is to provide a trapping device having a first trapdoor that is pivotally turned from a horizontal to a vertical position to confine an animal/insect entered an upper space of the trapping device and passed infrared sensors provided in the upper space, and a second trapdoor that is correspondingly turned from a horizontal to a vertical position to open a lower space of the trapping device to trap the animal/insect in the lower space; and the first and the second trapdoor automatically return to the horizontal position when a preset time passed.

Another object of the present invention is to provide a trapping device that could be repeatedly used over a prolonged time for catching at least two different types of animals and/or insects.

To achieve the above and other objects, the trapping device of the present invention includes a main body divided into upper lure and lower detention compartments, and a trapping mechanism located between the two compartments. The lure compartment has a front entrance, via which animals or insects go into the main body, and a floor opening for communicating with the detention compartment. A bait is positioned in the lure compartment at a deep rear portion thereof. The detention compartment has a gate, via which trapped animals or insects are cleared off. The trapping mechanism includes at least two infrared sensors provided in the lure compartment, a first trapdoor vertically dividing the lure compartment into front and rear rooms, a second trapdoor horizontally closing the floor opening, and a control circuit board for receiving signals from the infrared sensors to control closing or opening of the first and the second trapdoor. When an animal/insect passes through the infrared sensors, the first trapdoor is pivotally turned from a horizontal position to the vertical position to confine the animal/insect in the rear room of the lure compartment, and the second trapdoor from the horizontal position to a vertical position to open the floor opening for the animal/insect to fall into the detention compartment. The second trapdoor restores to the horizontal position to close the floor opening again when a preset time passed, and the first trapdoor is returned to the horizontal position 20 seconds later.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled perspective view of a trapping device according to the present invention; and

FIGS. 2, 3, and 4 show the trapping device of the present invention in use.

### DETAILED DESCRIPTION OF THE PREFERRED EMBODIMENTS

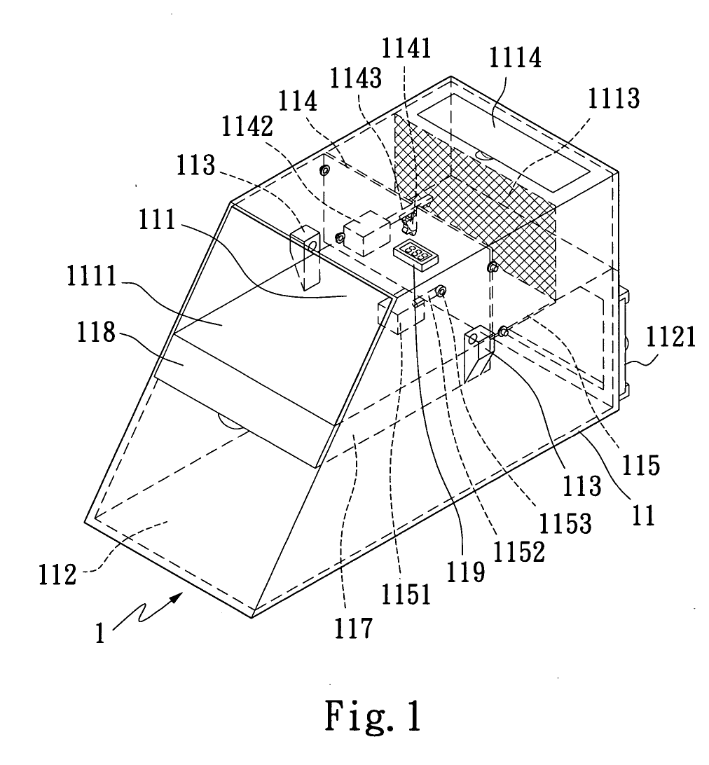

Please refer to FIG. 1 that is an assembled perspective view of a trapping device 1 according to an embodiment of the present invention. As shown, the trapping device 1 includes a main body 11 for trapping mice, cockroaches, etc. The main body 11 is internally divided into at least an upper lure compartment 111 and a lower detention compartment 112. A trapping mechanism is provided between the lure and the detention compartment 111, 112.

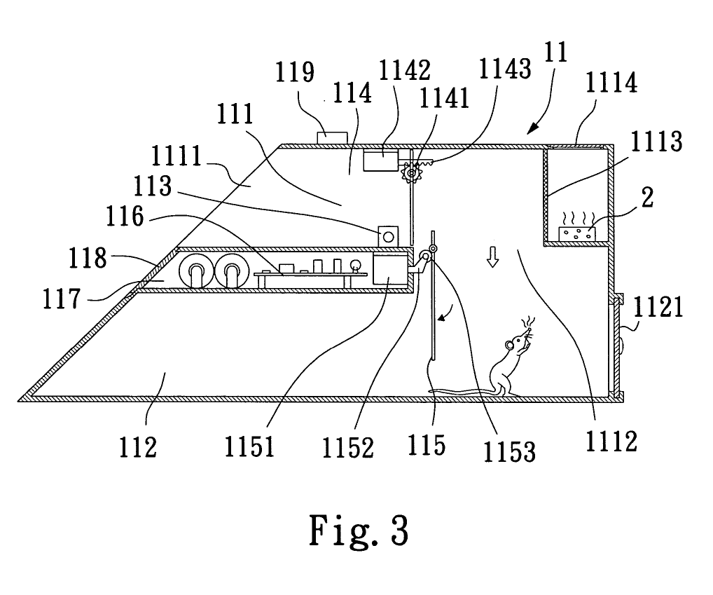

The lure compartment 111 is provided at a front side with an entrance 1111, via which mice and/or cockroaches go into the trapping device 1, at a middle portion with a floor opening 1112 for communicating the upper lure compartment 111 with the lower detention compartment 112, and near a rear side opposite to the front side and behind the floor opening 1112 with a vertical separating net 1113, behind which a bait 2 is positioned. A lid 1114 is provided at a top of the main body 11 corresponding to the place for positioning the bait 2 (also see FIG. 3).

The detention compartment 112 is located below the lure compartment 111, and is provided at a rear side with a gate 1121.

The trapping mechanism includes at least two infrared sensors 113 oppositely mounted on two lateral walls of the lure compartment 111, a first trapdoor 114 pivotally connected at two upper corners to upper locations of the two lateral walls of the lure compartment 111 to divide the lure compartment 111 into a front and a rear room, a second trapdoor 115 pivotally connected at two upper corners to upper locations of two lateral walls of the detention compartment 112, a control circuit board 116 (also see FIG. 3) for receiving signals from the infrared sensors 113 to control opening or closing movements of the first and the second trapdoor 114, 115.

The first trapdoor 114 is provided at a predetermined position with a gear wheel 1141 corresponding to a first electromagnetic valve 1142 mounted below the top of the lure compartment 111, such that the gear wheel 1141 engages with an extendable rack 1143 of the first electromagnetic valve 1142.

A second electromagnetic valve 1151 is provided in the detention compartment 112 to locate in front of the second trapdoor 115, such that a roller 1153 connected to a free end of a rearward extended extension rod 1152 of the second electromagnetic valve 1151 is in rotatable contact with a lower side of the second trapdoor 115 in the horizontal position.

The control circuit board 116 is located in an intermediate room 117 in a front portion of the main body 11 between the upper lure and the lower detention compartment 111, 112 to control movements of the extendable rack 1143 of the first electromagnetic valve 1142 and of the extension rod 1152 of the second electromagnetic valve 1151 according to the signals received from the infrared sensors 113, so as to open or close the first and the second trapdoor 114, 115. One side of the intermediate room 117 is provided with a movable cover 118.

A display 119 is provided on the top of the lure compartment 111 to electrically connect to the control circuit board 116 for showing the number of mice or cockroaches having been trapped in the detention compartment 112 of the trapping device 1. The display 119 may be, for example, a 7-segment light-emitting-diode (LED) display, a liquid crystal display (LCD), or other acceptable types of displays.

A warning device, such as an alarm, a flash lamp, etc. (not shown), may be optionally provided to connect to the control circuit board 116 for reminding a user that the number of trapped mice or cockroaches will soon reach a maximum detention capacity of the trapping device 1, so that the user could timely clear off the trapped mice or cockroaches and maintain the trapping device 1 in an optimal working condition.

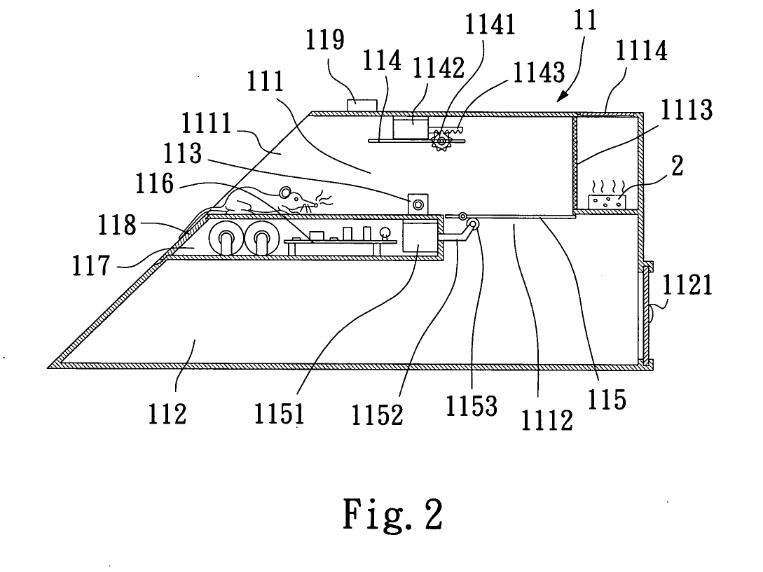

Please refer to FIGS. 2, 3, and 4 for the operation of the trapping device 1 of the present invention. It is noted the trapping device 1 with the above-described structure is applicable for trapping mice and cockroaches. As can be seen from FIGS. 2 to 4, a mouse attracted by the bait 2 goes into the lure compartment 111 of the main body 11 via the entrance 1111. Before the mouse passes through the infrared sensors 113, as shown in FIG. 2, the first trapdoor 114 is pivotally turned forward and upward to fixedly and parallelly locate below the top of the lure compartment 111, the second trapdoor 115 is in a horizontal position to close the floor opening 1112, and the rack 1143 and the extension rod 1152 of the first and the second electromagnetic valve 1142, 1151, respectively, are in an extended position.

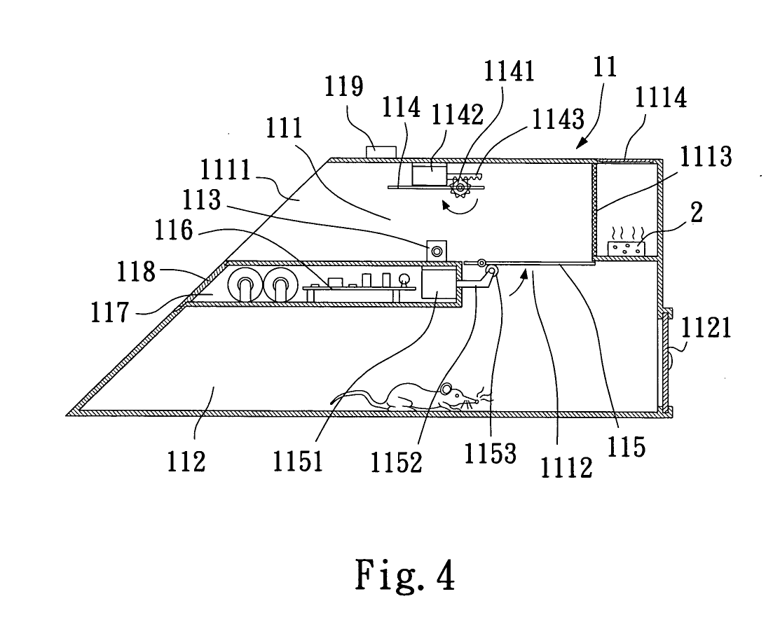

When the mouse passes through the infrared sensors 113 and approaches the bait 2 behind the separating net 1113 to locate on the second trapdoor 115, a signal is sent from the infrared sensors 113 to the control circuit board 116, so that the rack 1143 and the extension rod 1152 of the first and the second electromagnetic valve 1142, 1151, respectively, are moved to a retracted position. At this point, the first trapdoor 114 is pivotally turned downward and rearward to a vertical position to divide the lure compartment 111 into a front and a rear room, and the mouse is confined in the rear room without the risk of escaping from the entrance 1111; and the second trapdoor 115 is pivotally turned downward to a vertical position to open the floor opening 1112, so that the mouse falls into the detention compartment 112, as shown in FIG. 3. The first and the second trapdoor 114, 115 are maintained in the vertical position for a few seconds as preset for the trapping device 1. When the preset time passed, the second trapdoor 115 restores to the horizontal position first, and the first trapdoor 114 at a delayed time of twenty seconds, and the mouse is trapped in the detention compartment 112, as shown in FIG. 4, and the display 119 on the top of the main body 11 indicates one mouse is now trapped in the detention compartment 112. In this manner, the trapping device 1 of the present invention could be repeatedly used over a prolonged time to trap and detain different types of animals and insects.

What is claimed is:

1. A trapping device, comprising a main body for trapping animals and insects; said main body being internally divided into at least an upper lure compartment and a lower detention compartment, and provided between said lure and said detention compartment with a trapping mechanism;
said lure compartment being provided at a front side with an entrance, via which animals and/or insects go into said main body, at a middle portion with a floor opening for communicating said upper lure compartment with said lower detention compartment, and near a rear side opposite to the front entrance with a bait;
said detention compartment being located below said lure compartment, and provided at a rear side with a gate; and
said trapping mechanism including at least a plurality of infrared sensors, a first trapdoor dividing said lure compartment into a front and a rear room, a second trapdoor for opening or closing said floor opening of said lure compartment, and
a control circuit board for receiving signals from said infrared sensors to control opening or closing movements of said first and said second trapdoor.

2. The trapping device as claimed in claim 1, wherein said lure compartment is provided near the rear side opposite to said front entrance and behind said floor opening with a vertical separating net, behind which said bait is positioned, and at a top corresponding to said bait with a lid.

3. The trapping device as claimed in claim 1, wherein said infrared sensors are oppositely mounted on two lateral walls of said lure compartment.

4. The trapping device as claimed in claim 1, wherein said first trapdoor is pivotally connected at two upper corners to upper locations of two lateral walls of said lure compartment, and provided at a predetermined position with a gear wheel corresponding to a first electromagnetic valve mounted below the top of said lure compartment, such that said gear wheel engages with an extendable rack of said first electromagnetic valve.

5. The trapping device as claimed in claim 1, wherein said second trapdoor is pivotally connected at two upper corners to upper locations of two lateral walls of said detention compartment, and wherein a second electromagnetic valve is provided in said detention compartment to locate in front of said second trapdoor, such that a roller connected to a free end of a rearward extended extension rod of said second electromagnetic valve is in rotatable contact with a lower side of said second trapdoor in the horizontal position.

6. The trapping device as claimed in claim 1, wherein said main body is provided at a front portion with an intermediate room, in which said control circuit board of said trapping mechanism is mounted; and said intermediate room being provided at one side with a movable cover.

7. The trapping device as claimed in claim 1, wherein said main body is provided at a predetermined position with a display electrically connected to said control circuit board.

8. The trapping device as claimed in claim 7, wherein said display is selected from the group consisting of a seven-segment light-emitting-diode (LED) display and a liquid crystal display (LCD).
